(19) United States
(12) Patent Application Publication
(10) Pub. No.: US 2005/0053824 A1
(43) Pub. Date: Mar. 10, 2005

(54) Fuel cell system

(76) Inventors: Raimund Strobel, Ulm (DE); Stefan Lohr, Schelklingen (DE); Thomas Carle, Mengen (DE); Dieter Grafl, Ulm (DE); Dominique Tasch, Neu-Ulm (DE); Markus Lemm, Blaustein (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/496,446

(22) PCT Filed: Nov. 25, 2002
(86) PCT No.: PCT/EP02/13248

(30) Foreign Application Priority Data
Nov. 23, 2001 (DE) 101 58 771.6

(51) Int. Cl. H01M 8/02; H01M 8/04

(52) U.S. Cl. 429/37; 429/26; 429/38

(57) ABSTRACT

The invention relates to a fuel cell system (1) which is characterized in that a fuel cell stack (2) comprised of a plurality of intermediate plates is enclosed between two end plates (3) to compress the intermediate plates. At least one end plate (3) has an end plate base (4) and a contact surface plate (5) linked therewith to electrically contact the fuel cell stack. The end plate base (4) is furthermore provided with channel structures (6) designed for a cooling circuit for cooling the fuel cell stack. The end plate is deformed in such a manner that it is capable of applying an even compression to the fuel cell stack and to balance the setting behaviour of the stack and of the end plate.

The present invention relates to a fuel cell system according to the preamble of claim 1.

There are known fuel cell systems with which a fuel cell stack constructed of several intermediate plates and which represents a series arrangement of plate-like fuel cells is set between two end plates, for pressing together the intermediate plates.

This pressing-together is necessary for several reasons. On the one hand, by way of the pressure of the end plate it is effected that the individual intermediate plates i.e. the plates of individual fuel cells are pressed onto one another with an as uniform as possible pressure, so that the diffusion processes taking their course in the individual fuel cells as well as the ability to conduct current from plate to plate is ensured. Furthermore with most construction forms of fuel cell systems, the pressure of the end plates is necessary for the sealing function of gas or fluid circuits between the intermediate plates.

According to the state of the art, the end plates are joined from several individual parts for pressing the intermediate plates together. Thus for example it is usual to provide a metallic (mostly aluminium) plate which provides a sufficient mechanical strength for the forces which engage on the end plates. Furthermore additional components are usually provided for leading away the current of the fuel cell stack to an electrical consumer. Additionally, unions for conduits for the supply of media to the fuel cell stack are to be accommodated in the region of the end plates, and finally it is yet usual to provide a separate cooling unit on the end plate which thermally stabilises the fuel cell stack.

Such a design entails considerable disadvantages. On the one hand the assembly costs are quite high, furthermore the individual components must be built and joined together within strict tolerances so that the function of leading away the current, uniform pressing-together of the fuel cell stack as well as the cooling or the supply of media are possible without any problem. Additional problems may arise by way of the fact that for the electrical insulation between various components (such as unions for coolants as well as the leading-away of current), these need to be separated from one another. There further exists the disadvantage that the temperature management of the fuel cell stack is quite difficult, even with an end plate with which the above requirements are fulfilled, since the end plate usually contains metal parts of a high mass which due to their thermal capacity effect a sluggish reaction to the cooling demands of the fuel cell stack.

It is therefore the object of the present invention to create a fuel cell system with an end plate which on the one hand may exert a uniformly high pressure on a fuel cell stack and on the other hand is inexpensive and simple to manufacture as well as permits a good temperature management.

This object is achieved by a fuel cell system with an end plate according to claim 1.

The disadvantages of the state of the art are overcome by way of the fact that at least one end plate comprises an end plate base as well as a contact surface plate connected thereto for electrically contacting the fuel cell stack, wherein the end plate base comprises channel structures for a cooling circuit for cooling the fuel cell stack.

The end plate according to the invention is characterised by a simple construction. The end plate base has channel structures which permit the flow of a cooling circuit for cooling the fuel cell stack. By way of this a reduced effort is given since the channel structures are an integral component of the end plate and a separate cooling segment does not need to be provided. A further main component is the contact surface plate which electrically contacts the fuel cell stack and furthermore leads away the heat from the stack to the cooling circuit practically without any detour. By way of this the thermal sluggishness of the whole system is also reduced. Particular advantages lie in the fact that by way of the limited number of parts, the assembly costs and possible assembly errors are reduced. In particular for the inexpensive series manufacture of end plates, it lends itself to provide the end plate base as an injection moulded shape part.

Advantageous further embodiments of the present invention are specified in the dependent claims.

A particularly advantageous embodiment envisages the end plate base to be of plastic, for example a thermoplastic such as PA (Polyamide), PEEK (Polyetheretherketone), PPS (Polyphenylenesulfide), LCP (liquid crystallinie polymers), POM (Polyoxymethylene) or a thermoset such as PF (phenolic resins), MF (melamine-phenolic resins). Such an end plate base with its channel structures may for example be produced in series-scale production in a very inexpensive manner for example with the injection moulding method according to the state of the art. Plastic furthermore offers the particular advantage that it has a low mass and may thus be used for mobile applications. Furthermore plastics regularly have a lower heat capacity than usual metals so that by way of the cooling provided directly in the end plate base, on account of the less sluggish response behaviour a more direct cooling and thus an improved temperature management for the fuel cell stack occurs. Furthermore the electrically insulating properties of most plastics are furthermore to be emphasised as being favourable, which renders a separate electrical insulation of the contact surface plate superfluous.

In a further advantageous embodiment it is however also possible to manufacture the end plate base of metal, such as an aluminium die-cast part. Depending on the type of metal, under certain circumstances certain corrosion protection paints (coatings) are required for coating the metals.

A particularly advantageous embodiment envisages that side of the contact surface plate facing the end plate base being a limitation wall of the cooling circuit. The principle according to the invention is completely exploited by way of this. The end plate base in particular is easy to manufacture since the channel structures only need to be designed as simple recesses without complicated undercut cross sections. It is not necessary to manufacture the end plate base with complicated hollow casting methods. The sealing termination of the channel structures towards the fuel cell stack is accomplished via the contact surface plate. By way of this it is also achieved that a very direct heat removal from the fuel cell stack into the cooling circuit of the end plate is effected via the contact surface plate.

If no additional measures are taken, in the inside of the surface a non-uniform pressing force distribution may occur and thus an inhomogeneous pressing of the contact surface plate onto the stack surface by way of the screwing and clamping in the outer region. With plastic plates one must take particular note of such inhomogeneous pressing effects. Several measures are useful in order to avoid this. A particularly advantageous embodiment envisages integrating the contact surface plate into the end plate base such that the contact surface plate is crowned towards the fuel cell stack. By way of this an undesired sagging which may lead to an inhomogeneous pressing onto the stack surface is compensated by a predefined deformation on installation. Alternatively to this, the contact surface plate may also be shaped such that it is essentially plane towards the end plate base and is cambered towards the fuel cell stack. By way of this, on account of the current collector insert, the force is introduced into the stack such that a distortion is compensated. It is thus to be ensured that the cooling structure may be varied in it height such that a spherical sector shape (crowning, cambering) on the stack may be transferred or that the necessary homogeneous force distribution is introduced in the active region of the fuel cell in that the end plate is constructed by way of a suitable design in an elastic manner such that the forces may be built up from the outside by way of a central clamping.

It is particularly advantageous for the end plate base or the contact surface plate to comprise support elements for distributing the pressure load acting on the contact surface plate. By way of this one succeeds in homogeneously transferring the pressing of the end plate homogeneously towards the fuel cell stack via the whole surface of the contact surface plate. This uniform pressing also effects a uniform pressing of all further intermediate plates of the fuel cell stack so that a good electrical contact arises between the individual plates. This results in good efficiencies of the fuel cell system. The support elements according to the invention may be manufactured in a simple an inexpensive manner with manufacturing methods according to the state of the art (such as plastic injection moulding method).

It is additionally possible for example to provide support struts/braces on that rear side of the end plate base which is distant to the contact surface plate, for reinforcing in particular end plate base bodies of plastic. Thus also with end plate base bodies with a very low mass one may achieve a stiff cross section so that the uniform pressing may be realised on the fuel cell stack even with a lightweight construction.

A further advantageous embodiment envisages arranging sealing means between the contact surface plate and the end plate base in order to prevent cooling fluid from running out of the channel structures. For this for example a separate sealing element (such as a rubber seal) may be provided. The contacts surface plate is then for example fixed with a snap locking connection. It is however also conceivable to injection (mould) the contact surface plate directly into the end plate base or to melt it together with this (this method in particular lends itself with end plate base bodies of plastic).

Various embodiments are also conceivable for the contact surface plate itself. It is thus possible to provide this as a whole from a metal (such as stainless steel, aluminium or copper with 0.5-3 mm thickness). At the same time, according to the metal, the deposition of a corrosion protective coating on the metal may also be useful under certain circumstances.

It is however also possible to design the contact surface plate as a metallically coated plastic plate. With this, an aluminium or copper foil of a low thickness advantageously of 0.1 to 1 mm may be deposited onto a metal or plastic plate on the side facing the fuel cell stack. At the same time, the electrical insulating properties of many plastics are advantageous which render additional insulation superfluous. However one must take care with regard to a sufficient support of the plastic plate in order to ensure a uniform surface pressing for the fuel cell stack. Furthermore an electrically conductive corrosion coating is to be provided for the contact surface plate.

The particular advantage of the system according to the invention is the fact that the connections for various media are easy to attach on the end plate. The current connection may for example be designed as a projecting tab of the contact surface which may be simply connected to the electrical consumer. Furthermore inlets and outlets for gases or fluids may be easily provided on the end plate base and these may be connected to corresponding inlets and outlets of the fuel cells stack for the supply of media (such as H₂, O₂, air, methanol etc.). Coolant inlets and coolant outlets to the channel structures which lead fluid are just as easily possible. All these inlets and outlets may be designed as hole-like openings in the end plate base or also as supports (unions). With this, on manufacturing the end plate base with the injection moulding method it is simply possible to integrally form the unions. With an end plate base of plastic at the same time all further electrical sealing may be done away with. It is however also possible to design the unions as separate components and to couple them firmly to the end plate base only later.

A further advantageous embodiment envisages the contact surface plate on its side facing the fuel cell stack to have such a three-dimensional structure that reactants may be led via this structure. This means that a so-called flowfield is an integral component of the contact surface plate. By way of this e.g. it is possible to lead a reaction gas such as molecular hydrogen distributed in a large-surfaced manner over the contact surface plate so that a homogeneous surface distribution is given

One further advantageous embodiment envisages the end plate base on its side facing the fuel cell stack to comprise seals for sealing the inlets or outlets for gases or fluids as well as for sealing electrochemically active regions of the fuel cell stack. With this it may be the case e.g. of elastomer seals which are incorporated into the grooves of the end plate base. On pressing the end plates towards one another it is thus ensured at the same time that the supply of media is sealed. It is also alternatively possible for the contact surface plate to extend essentially over the whole surface of the end plate base and on its side facing the fuel cell stack to comprise the seal for sealing the inlets or outlets for media as well as the electromechanically active regions of the fuel cell stack. In this case the channels for the gases or fluids go through the contact surface plate. In particular with metallic contact surface plates the deposition of seals is possible in an inexpensive manner, such as by way of an elastomer deposition by way of the screen-printing method.

With this variant, additionally the contact surface plate on its side facing the end plate base may comprise seals. Thus e.g. in this region elastomer seals may be provided between the end plate base and the contact surface plates (this e.g. is necessary if the contact surface plate simultaneously represents a limitation wall of the cooling circuit arranged in the end plate base). At the same time a snap or fixation mechanism (e.g. by way of pointwise thermal fixation) should additionally be effected between the contact surface plate and the end plate base in order to position these components to one another as desired. The final sealing effect then comes into effect as soon as the fuel cell stack is clamped onto the end plates by way of exerting pressure.

Further advantageous embodiments are described in the further dependent claims.

The present invention is now explained by way of several figures. There are shown in:

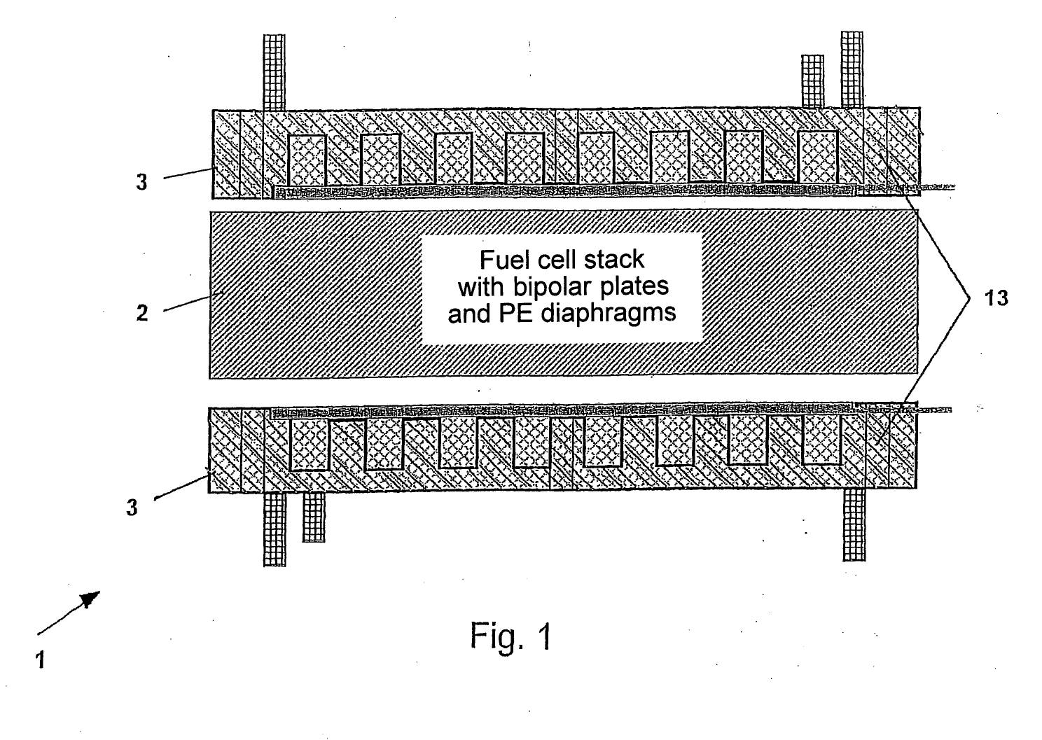

FIG. 1 a fuel cell system according to the invention,

FIG. 2 an end plate according to the invention,

FIGS. 3a and 3b views of the end plate base according to the invention, and

FIG. 4 crowning of a contact surface plate.

FIG. 1 shows a fuel cell system 1 according to the invention. Here one may see a fuel cell stack 2 constructed of several intermediate plates consisting of a successive layering of several plate-like fuel cells which are electrically connected in series. This fuel cell stack is arranged between two end plates 3. The exertion of pressure forces onto the fuel cell stack is for example possible by way of clamping bolts which in each case are guided through-holes 13 and on those rear sides of the end plates which are distant to the fuel cell stack are fixed by a locknut. Alternatively tightening (clamping) straps or tightening (clamping) anchors are possible for producing these pressure forces.

The more detailed construction of an individual end plate 3 is now explained by way of FIG. 2. This shows an end plate base 4 as well as a contact surface plate 5 connected thereto or inserted therein, for the electrical contacting of the fuel cell stack 2 (FIG. 2 shows a still unassembled position of the contact surface plate 5, the completed installation position is to be recognised in the end plates in FIG. 1). The end plate base 4 comprises channel structures 6 for a cooling circuit for cooling the fuel cell stack. The end plate base 4 is mainly manufactured of a plastic injection moulded part. Here it is in particular the low mass as well as the low thermal capacity which are particularly advantageous, so that the cooling circuit may practically directly influence the temperature in the fuel cell stack without losses due to sluggishness.

That side 5.1 of the contact surface plate 5 which faces the end plate base 4 is a limitation wall of the cooling circuit. The channel structures are designed as recesses of the end plate base which is open on one side. Several channels lying next to one another are shown in the cross sectional drawing in FIG. 2, which are separated from one another by way of projections or support elements 7. Such a shape may be easily realised with regard to manufacturing technology since the channel structure has no undercuts. The contact surface plate 5 is fixed onto the support elements 7 such that the channels of the channel structure 6 are completely closed. At the same time it is advantageous for the support elements 7 to support the contact surface plate 5 over a very broad surface so that no sagging of the contact surface plate, such as in its centre, may occur and thus a non-uniform pressing behaviour of the fuel cell stack may not occur. Peripheral sealing means 8 may be attached between the contact surface plate 5 and the end plate base 4 in order to prevent a leakage of the coolant which flows through the channel structure. An adhering (bonding) may be provided as sealing means. However other separate sealing elements such as a rubber seal are also possible. A thermal bonding between the contact surface plate and the end plate base is also possible, depending on the material.

The contact surface plate is mainly of a plastic which is covered over the whole surface with a copper foil with a thickness of 0.2 mm on the side which faces the fuel cell stack. Alternatively it is also possible to provide the contact surface plate completely of metal. The contact surface plate has a conducting branch, the current connection 9, with which an electrical connection from the fuel cell stack via the contact surface plate to an electrical consumer connected to the current connection 9 is possible.

The end plate base 4 furthermore shows an inlet 10 for supplying reaction gas (such as air or hydrogen) as well as an outlet 11 for reaction gas as well as a coolant inlet 12 which is connected with a channel structure 6 for operating the cooling circuit. The inlet 10 or the outlet 11 for gas as well as the coolant inlet 12 are furthermore connected to corresponding openings of the fuel cell stack and the corresponding supply and removal of gases and fluids via channels which are not shown in more detail. The inlets or outlets 10, 11 and 12 are formed as supports (unions) which are attached as separate components on the rear side of the end plate which is distant to the fuel cell stack.

FIGS. 3a and 3b show a front as well as a rear view of an end plate base according to the invention. This has an essentially square surface cross section. However systems with a round or non-square rectangular cross section are also possible. The end plate base is designed as a plastic injection moulded part. In FIG. 3a the channel structure 6′ with the support elements 7′ is to be seen, onto which the contact surface plate is later applied. The triangular recesses in the edge region of the end plate base serve for connecting the cooling region of the end plate to the cooling region of the fuel cell stack. The inlet 10′, the outlet 11′ as well as the coolant inlet 12′ are designed as integral unions of the plastic end plate base 4′. This is advantageous with regard to the leak tightness, manufacturing costs as well as possible electrical insulation of the unions.

The inlet 10′ and the outlet 11′ open into openings 10a′ and 11a′ respectively, via which a gas-conducting connection to the fuel cell stack is possible. The coolant inlet 12′ opens into the channel structure 6′ which is interrupted by support elements 7′ which cross the end plate base in an essentially web-like and diagonal manner.

In FIG. 3b one may see that an edge-side frame with star-shaped reinforcement struts running in a tapered manner towards the centre of the end plate base is arranged on the rear side of the end plate base, for increasing the flexural strength of the end plate base. A full-surfaced pressing of the fuel cell stack over its entire area is achieved by way of this.

In a schematic manner, FIG. 4 shows how a homogeneous pressing onto the fuel cell stack surface is achieved by way of crowning the contact surface plate. For this a contact surface plate 5 is incorporated into an end plate base 4 such that it is crowned towards the fuel cell stack 2. With an axial clamping of the end plate base as well as the fuel cell stack 2 which e.g. takes place by way of screwing in the edge region, in the central region of the contact surface plate 5 a deformation occurs by which means as a whole, on account of the circular sector shape of the cambering, in particular a homogeneous pressing of the contact surface plate onto the stack surface is achieved. This effect may also be alternatively achieved by way of a cambering of the contact surface plate (see introductory description). Then as a whole one may ascertain that the end plate is deformed such that it may transmit a uniform pressing onto the stack, and well as that it may further compensate the setting behaviour of the stack and/or also the end plate.

1. A fuel cell system (1) with which a fuel cell stack (2) constructed of several intermediate plates is set between two end plates (3) for pressing the intermediate plates together,
characterised in that at least one end plate (3) comprises an end plate base (4) as well as a contact surface plate (5′) connected thereto for electrically contacting the fuel cells stack, wherein the end plate base (4) comprises channel structures (6) for a cooling circuit for cooling the fuel cell stack.

2. A fuel cell system according to claim 1, characterised in that the end plate base (4) is of plastic.

3. A fuel cell system according to one of the preceding claims, characterised in that the end plate base (4) is of a die-cast metal, of a cast metal or of a foam metal.

4. A fuel cell system according to one of the preceding claims, characterised in that that side (5.1) of the contact surface plate (5) facing the end plate base (4) is a limitation wall of the cooling circuit.

5. A fuel cell system according to one of the preceding claims, characterised in that the end plate base (4) and/or the contact surface plate (S) comprises support elements (7) for distributing the pressure load acting onto the contact surface plate (5), towards the end plate base (4).

6. A fuel cell system according to one of the preceding claims, characterised in that sealing means are arranged between the contact surface plate (5) and the end plate base (4).

7. A fuel cell system according to one of the preceding claims, characterised in that the contact surface plate (5) is injected into the end plate base (4) or is melted with this.

8. A fuel cell system according to one of the preceding claims, characterised in that the contact surface plate (5) is of metal.

9. A fuel cell system according to one of the claims 1 to 7, characterised in that the contact surface plate (5) is a metallically coated plastic plate.

10. A fuel cell system according to one of the preceding claims, characterised in that the contact surface plate is in contact with a current connection (9) for the electrical connection of the fuel cell system (1) to an electrical consumer.

11. A fuel cell system according to one of the preceding claims, characterised in that the end plate (3) comprises inlets (10) and/or outlets (11) for gases or fluids, wherein the inlets and/or outlets in each case are in connection with corresponding openings of the fuel cell stack via channels.

12. A fuel cell system according to one of the preceding claims, characterised in that the end plate (3) comprises coolant inlets (12) and coolant outlets, connected to the channel structures (6) for the cooling circuit.

13. A fuel cell system according to one of the claims 11 or 12, characterised in that the inlets (10, 12) and/or outlets (11) are designed as hole-like openings in the end plate, as integral unions or as unions designed as separate components.

14. A fuel cell system according to one of the preceding claims, characterised in that the end plate comprises through-holes (13) for leading through clamping bolts, or reliefs for accommodating clamping belts, for exerting pressure onto the fuel cell stack.

15. A fuel cell system according to one of the preceding claims, characterised in that the contact surface plate on its side facing the fuel cell stack (2) comprises such a three-dimensional structure that reactants may be led via this structure.

16. A fuel cell system according to claim 11, characterised in that the end plate base (5) on its side facing the fuel cell stack (2) comprises seals for sealing the inlets (10) or outlets (11) for gases or fluids as well as electrochemically active regions of the fuel cell stack (2)

17. A fuel cell system according to claim 11, characterised in that the contact surface plate (5) on its side facing the fuel cell stack (2) comprises seals for sealing the inlets (10) or outlets (11) for gases or fluids as well as electrochemically active regions of the fuel cell stack (2).

18. A fuel cell system according to claim 17, characterised in that the contact surface plate (5) additionally comprises seals on its side facing the end plate base (4).

19. A fuel cell system according to one of the preceding claims, characterised in that the contact surface plate is incorporated into the end plate base such that the contact surface is crowned towards the fuel cell stack

20. A fuel cell system according to one of the preceding claims, characterised in that the contact surface plate towards the end plate base is essentially plane and is cambered towards the fuel cell stack.
